(19) United States
(12) Patent Application Publication
(10) Pub. No.: US 2025/0223464 A1
(43) Pub. Date: Jul. 10, 2025

(54) METHOD OF MANUFACTURING PREPOLYMER SOLUTION AND METHOD OF MANUFACTURING INSULATED ELECTRIC WIRE

(71) Applicants: SUMITOMO ELECTRIC INDUSTRIES, LTD., Osaka (JP); SUMITOMO ELECTRIC WINTEC, INC., Shiga (JP)

(72) Inventors: Shogo TAKAHARA, Osaka (JP); Shingo NAKAJIMA, Osaka (JP); Masuo IIDA, Osaka (JP); Masaaki YAMAUCHI, Osaka (JP); Hirotsugu MOCHIDA, Shiga (JP)

(73) Assignees: SUMITOMO ELECTRIC INDUSTRIES, LTD., Osaka (JP); SUMITOMO ELECTRIC WINTEC, INC., Shiga (JP)

(21) Appl. No.: 18/856,647

(22) PCT Filed: May 31, 2022
(86) PCT No.: PCT/JP2022/022232

§ 371 Date: Oct. 14, 2024

(51) Int. Cl. C09D 179/08; C08G 73/10; H01B 3/30; H01B 13/00

(52) U.S. Cl. CPC C09D 179/08; C08G 73/1032; C08G 73/1067; H01B 3/306; H01B 13/0016

(57) ABSTRACT

A method for producing a prepolymer solution according to one embodiment of the present disclosure, the method continuously producing a prepolymer solution wherein a prepolymer, which is a precursor of a thermosetting resin, is dissolved in a solvent, comprises a step in which a first starting material, a second starting material that reacts with the first starting material so as to form the prepolymer, and the solvent are mixed with each other.

### TECHNICAL FIELD

The present disclosure relates to a method of manufacturing a prepolymer solution and a method of manufacturing an insulated electric wire.

### BACKGROUND ART

Patent literature 1 describes a polymer production system for producing a first polymer using a raw material fluid containing a polyaddition first polymerizable compound and a raw material powder containing a polyaddition second polymerizable compound as raw materials, the system including a raw material fluid supply unit for continuously supplying the raw material fluid, a raw material powder supply unit for continuously supplying the raw material powder, a first mixing section for continuously mixing the raw material fluid and the raw material powder to produce a first mixed fluid, and a first reaction unit disposed downstream of the first mixing section for promoting a polymerization reaction of the first mixed fluid to produce a first polymerized fluid.

### CITATION LIST

### Patent Literature

Patent literature 1: Japanese Unexamined Patent Application Publication No. 2021-31610

### SUMMARY OF INVENTION

A method of manufacturing a prepolymer solution according to an aspect of the present disclosure is the method of continuously manufacturing a prepolymer solution in which a prepolymer as a precursor of a thermosetting resin is dissolved in a solvent. The method includes mixing, using an extruder, a first raw material, a second raw material that reacts with the first raw material to form the prepolymer, and the solvent.

### BRIEF DESCRIPTION OF THE DRAWINGS

FIG. 1 is a schematic view showing a method of manufacturing a prepolymer solution according to an embodiment of the present disclosure.

FIG. 2 is a schematic view showing a method of manufacturing a prepolymer solution according to an embodiment of the present disclosure.

FIG. 3 is a schematic view showing a method of manufacturing a prepolymer solution according to an embodiment of the present disclosure.

### DETAILED DESCRIPTION

### Problems to be Solved by Present Disclosure

From the viewpoint of improving the productivity of the prepolymer solution and reducing the production cost, a method of continuously manufacturing the prepolymer solution is required.

Further, for example, when a prepolymer solution is used as a material for forming an insulating layer of an insulated electric wire, it is necessary to remove a solvent contained in the prepolymer solution. Thus, a method of manufacturing a high-concentration prepolymer solution is required in order to reduce the amount of the solvent to be removed.

The present disclosure has been made in view of the above circumstances, and an object is to provide a method of manufacturing a prepolymer solution, which can continuously manufacture a high-concentration prepolymer solution.

### Advantageous Effects of Present Disclosure

The method of manufacturing a prepolymer solution according to an aspect of the present disclosure can continuously manufacture a high-concentration prepolymer solution.

### DESCRIPTION OF EMBODIMENTS OF PRESENT DISCLOSURE

First, embodiments of the present disclosure will be listed and described.

A method of manufacturing a prepolymer solution according to an aspect of the present disclosure is the method of continuously manufacturing a prepolymer solution in which a prepolymer as a precursor of a thermosetting resin is dissolved in a solvent. The method includes mixing, using an extruder, a first raw material, a second raw material that reacts with the first raw material to form the prepolymer, and the solvent.

The method of manufacturing a prepolymer solution can continuously manufacture a high-concentration prepolymer solution by mixing the first raw material, the second raw material, and the solvent using an extruder. The term “high-concentration” means that the solid content of the prepolymer solution is 25% by mass or more. The term “solid content” means the ratio of the total mass of all components other than the solvent to the total mass of the prepolymer solution. The term “continuously manufactured” means that the prepolymer solution is continuously manufactured for a certain period of time. This is different from the “batch production”.

In the mixing, a reaction control agent is preferably further mixed. In this case, the viscosity of the prepolymer solution can be reduced. This allows the viscosity to be such that insulated electric wires can be manufactured.

It is preferable that the method further includes measuring a viscosity of the prepolymer solution obtained by the mixing. An amount of the reaction control agent supplied in the mixing is preferable determined based on a measurement value of the viscosity obtained by the measuring. In this case, the viscosity of the prepolymer solution can be easily controlled.

It is preferable that the method further includes stirring the prepolymer solution obtained by the mixing. In this case, the variation in the viscosity of the prepolymer solution can be reduced.

A solid content of the prepolymer solution is preferably 20/6 by mass to 50% by mass. In this case, the number of times of repeated applying can be reduced when forming an insulating layer having a target film thickness, and the production efficiency can be improved.

It is preferable that the prepolymer has a group capable of forming an imide group through a dehydration reaction, the first raw material is a carboxylic anhydride, and the second raw material is a diamine compound. In this case, the heat resistance of the thermosetting resin obtained by curing the prepolymer solution can be improved.

It is preferable that the prepolymer is a polyimide prepolymer, and the carboxylic anhydride is a tetracarboxylic dianhydride. In this case, the heat resistance of the thermosetting resin obtained by curing the prepolymer solution can be further improved.

The extruder is preferably a twin-screw extruder. In this case, the residence time required for the formation of the prepolymer can be sufficiently ensured. By ensuring a sufficient residence time, the unreacted prepolymer can be reacted, and as a result, the mechanical strength of the insulated electric wire can be improved.

In the measuring, the viscosity is preferably measured with a vibration viscometer. In this case, the prepolymer can be manufactured without impairing the continuous productivity of the prepolymer solution.

The stirring is preferably performed under a condition of 20° C. to 200° C. In this case, the variation in the viscosity can be reduced by stirring for a short time without causing the volatilization of the solvent.

A method of manufacturing an insulated electric wire is a method of manufacturing an insulated electric wire including a conductor and an insulating layer covering the conductor, the method inluces: applying a prepolymer solution obtained by the method of manufacturing a prepolymer solution to an outer peripheral side of the conductor; and heating the prepolymer solution applied to the conductor.

The method of manufacturing an insulated electric wire can continuously manufacture an insulated electric wire having appropriate characteristics by using the prepolymer solution obtained by the method of manufacturing a prepolymer solution as a material for forming an insulating layer.

### Details of Embodiments of Present Disclosure

Hereinafter, a method of manufacturing a prepolymer solution and a method of manufacturing an insulated electric wire according to an embodiment of the present disclosure will be described in detail.

### Method of Manufacturing of Prepolymer Solution

The method of manufacturing a prepolymer solution, the method being a method of continuously manufacturing a prepolymer solution in which a prepolymer as a precursor of a thermosetting resin is dissolved in a solvent, the method includes a step of mixing (hereinafter, also referred to as a “mixing step”), using an extruder, a first raw material, a second raw material that reacts with the first raw material to form the prepolymer, and the solvent.

The method of manufacturing a prepolymer solution preferably further includes a step of measuring a viscosity of the prepolymer solution obtained by the mixing step (hereinafter, also referred to as “viscosity measuring step”).

The method of manufacturing a prepolymer solution preferably further includes a step of stirring the prepolymer solution obtained by the mixing step (hereinafter, also referred to as a “stirring step”).

The method of manufacturing the prepolymer solution may include other steps other than the mixing step, the viscosity measuring step, and the stirring step. Examples of the other steps include a supply amount measurement step, a pressure measurement step, a refractive index measurement step, a density measurement step, a temperature measurement step, a flow rate measurement step, a chromaticity measurement step, an absorbance measurement step, a conductivity measurement step, a turbidity measurement step, and an infrared spectrometry step.

The prepolymer solution is a solution in which a prepolymer serving as a precursor of a thermosetting resin is dissolved in a solvent. Examples of the thermosetting resin include polyimide, polyamide-imide, polyetherimide, and polyester. Among these, a thermosetting resin having an imide group is preferable, and polyimide is more preferable.

The prepolymer is a precursor of the thermosetting resin. For example, when the thermosetting resin is polyimide, the prepolymer is polyamic acid as a precursor of polyimide. The polyamic acid undergoes a cyclodehydration reaction by heating or the like to form a cyclic imide group, thereby forming a polyimide.

The lower limit of the solid content of the prepolymer solution obtained by the method of manufacturing the prepolymer solution is preferably 20% by mass, more preferably 24% by mass, and still more preferably 28% by mass. According to the method of manufacturing a prepolymer solution, a high-concentration prepolymer solution having a solid content of 20% by mass or more can be manufactured. In addition, the amount of the solvent can be relatively reduced. The upper limit of the solid content is preferably 50% by mass, more preferably 45% by mass, still more preferably 40% by mass, and even more preferably 36% by mass. The solid content of the prepolymer solution can be adjusted by the supply amounts of the first raw material, the second raw material, and the solvent, and the like.

The lower limit of the viscosity of the prepolymer solution at 30° C. is preferably 5 Pa-s. The upper limit of the viscosity of the prepolymer solution at 30° C. is preferably 450 Pa-s. When the viscosity of the prepolymer solution at 30° C. is less than the lower limit, it is difficult to uniformly apply the prepolymer solution, and the covering of the insulated electric wire may be insufficient. When the viscosity of the prepolymer solution at 30° C. exceeds the upper limit, there is a concern that it may be difficult to apply the prepolymer solution. The viscosity of the prepolymer solution is a value measured by an E-type viscosity meter (“TV-25” manufactured by Toki Sangyo Co., Ltd).

The lower limit of the weight average molecular weight (Mw) of the prepolymer in terms of polystyrene is preferably 10,000, and more preferably 15,000. The upper limit of Mw of the prepolymer in terms of polystyrene is preferably 100,000, and more preferably 80,000. When Mw of the prepolymer in terms of polystyrene is less than the lower limit, the film elongation may be insufficient when the insulating layer of the insulated electric wire is formed. When Mw of the prepolymer in terms of polystyrene exceeds the upper limit, the viscosity of the prepolymer solution may be excessively increased.

The equivalent number average molecular weight (Mn) of the prepolymer in terms of polystyrene is preferably 5,000 to 50,000.

The ratio of Mw to Mn (Mw/Mn) of the prepolymer is preferably 1.5 to 4.0.

Mw, Mn and Mw/Mn of the prepolymer solution are values in terms of polystyrene measured by gel permeation chromatography in accordance with JIS-K7252-1:2008 “Plastics-Determination of average molecular weights and molecular weight distributions of polymers by size exclusion chromatography-First part: General rules”.

### (Mixing Step)

In this step, the first raw material, the second raw material that reacts with the first raw material to form the prepolymer, and the solvent are mixed using an extruder. In this step, a high-concentration prepolymer solution can be continuously manufactured by using an extruder.

In this step, the first raw material and the second raw material react with each other to form a prepolymer.

The mixing time is preferably 30 seconds to 60 minutes. In this case, it is possible to sufficiently ensure a time for forming the polymer without gelation due to excessive curing of the prepolymer solution. The mixing temperature is preferably 20° C. to 200° C. In this case, the temperature for forming the polymer can be sufficiently ensured without gelation due to excessive curing of the prepolymer solution.

The prepolymer is not particularly limited as long as it is a precursor of the thermosetting resin described above. Among these, a prepolymer having a group capable of forming an imide group through a dehydration reaction is preferable, and a polyimide prepolymer is more preferable.

When the prepolymer is a prepolymer having a group capable of forming an imide group through a dehydration reaction, the first raw material is a carboxylic anhydride, and the second raw material is a diamine compound. When the first raw material and the second raw material are the materials described above, a prepolymer having a group capable of forming an imide group through a dehydration reaction is formed in this step. In this case, the heat resistance of the thermosetting resin obtained by curing the prepolymer solution can be improved.

Examples of the carboxylic anhydride include tetracarboxylic dianhydride.

Examples of the diamine compound include: an aliphatic diamine such as hexamethylenediamine, 1,2-diaminotetradecane, 1,2-diaminoheptadecane, 1,2-diaminooctadecane, 1,9-diaminononane, 2,2-dimethyl-1,3-propanediamine, or 1,11-diaminoundecane; and an aromatic diamine such as m-phenylenediamine, p-phenylenediamine, 2,4-diaminotoluene, 4,4′-diamino-3,3′-dimethyl-1,1′-biphenyl, 4,4′-diamino-3,3′-dihydroxy-1,1′-biphenyl, 3,4′-diaminodiphenyl ether, 4,4′-diaminodiphenyl ether, 3,3′-diaminodiphenyl sulfone, 4,4′-diaminodiphenyl sulfone, 4,4′-diaminodiphenyl sulfide, 2,2-bis(4-aminophenyl) propane, 2,2-bis(4-aminophenyl) hexafluoropropane, 1,3-bis(4-aminophenoxy) benzene, 1,4-bis(4-aminophenoxy) benzene, 4,4′-bis(4-aminophenoxy) biphenyl, 2,2-bis [4-(4-aminophenoxy) phenyl]propane, 2,2-bis [4-(4-aminophenoxy) phenyl]hexafluoropropane, bis [4-(3-aminophenoxy) phenyl]sulfone, bis [4-(4-aminophenoxy) phenyl]sulfone, 2,6-diaminopyridine, 2,6-diamino-4-methylpyridine, 4,4′-(9-fluorenylidene) dianiline, or α,α-bis(4-aminophenyl)-1,3-diisopropylbenzene.

The diamine compound is preferably an aromatic diamine. In this case, the mechanical strength of the thermosetting resin obtained by curing the prepolymer solution can be improved.

When the prepolymer is a polyimide prepolymer, the carboxylic anhydride is preferably a tetracarboxylic dianhydride. In this case, the heat resistance of the thermosetting resin obtained by curing the prepolymer solution can be further improved.

Examples of the tetracarboxylic dianhydride include: an aliphatic tetracarboxylic dianhydride such as 1,1,2,2-ethanetetracarboxylic dianhydride, 1,2,3,4-butanetetracarboxylic dianhydride, 1,2,3,4-cyclobutanetetracarboxylic dianhydride, or bicyclo [2.2.2]oct-7-ene-2,3,5,6-tetracarboxylic dianhydride; and an aromatic tetracarboxylic dianhydride such as pyromellitic dianhydride, 3,3′,4,4′-biphenyltetracarboxylic dianhydride, bis(3,4-dicarboxyphenyl) ether dianhydride, 3,3′,4,4′-benzophenonetetracarboxylic dianhydride, 2,2-bis(3,4-dicarboxyphenyl) hexafluoropropane dianhydride, or 3,3′,4,4′-biphenylsulfone tetracarboxylic dianhydride.

As the tetracarboxylic dianhydride, an aromatic tetracarboxylic dianhydride is preferred. In this case, the mechanical strength of the thermosetting resin obtained by curing the prepolymer solution can be improved.

The supply amounts of the first raw material and the second raw material can be appropriately determined according to the target solid content of the prepolymer solution. The molar ratio of the first raw material to the second raw material (first raw material: second raw material) can be, for example, 95:105 to 105:95, more preferably 97:103 to 103:97, and still more preferably 99:101 to 101:99. The first raw material and the second raw material are preferably used in substantially equimolar amounts. When the prepolymer solution is used as a material for forming an insulating layer of an insulated electric wire, an insulated electric wire excellent in film elongation, dielectric breakdown voltage and relative permittivity can be formed. The term “substantially equimolar amounts” means a range in which the molar ratio of the first raw material to the second raw material (first raw material: second raw material) is 99:101 to 101:99.

In this step, raw materials other than the first raw material and the second raw material can be supplied within a range not impairing the effect of the present disclosure.

As the solvent, a solvent is selected which has a high solubility for the prepolymer, which is a reaction product of the first raw material and the second raw material, and which does not react with the first raw material, the second raw material, and the prepolymer. As such a solvent, an aprotic polar organic solvent is preferred. By using a solvent that does not have a proton that can react with the prepolymer, it is possible to avoid the progress of side reactions between the solvent and the raw material or the prepolymer. In addition, since the solvent is a polar organic solvent, the prepolymer having polarity can be sufficiently dissolved.

Examples of the aprotic polar organic solvent include N-methyl-2-pyrrolidone (NMP), N,N-dimethylacetamide (DMAc) and N,N-dimethylformamide, dimethyl sulfoxide.

The supply amounts of the solvent can be appropriately determined according to the target solid content of the prepolymer solution.

The extruder is not particularly limited as long as it is a device having an extruder mechanism, and examples thereof include a single-screw extruder, a twin-screw extruder, a quad-screw extruder, and an octa-screw extruder. Among these, a twin-screw extruder is preferable. In this case, the residence time required for forming the prepolymer can be sufficiently ensured while keeping the equipment costs down.

In this step, it is preferable to further mix a reaction control agent in addition to the first raw material, the second raw material, and the solvent. The reaction control agent reacts with a part of carboxylic anhydride groups located at the ends of the prepolymer to seal the ends of the polymer chains. By using the reaction control agent, the polymerizability of the first raw material can be controlled, and as a result, the viscosity of the prepolymer solution can be reduced.

Examples of the reaction control agent include water (H₂O), alcohols having 1 to 15 carbon atoms, and the like. Examples of the alcohol having 1 to 15 carbon atoms include monohydric alcohols such as ethanol, methanol, propanol, butanol, and pentanol; and polyhydric alcohols such as ethylene glycol, propylene glycol, and glycerin. Among these, water or methanol is preferable from the viewpoint of reactivity and cost.

The supply amounts of the reaction control agent can be appropriately determined based on the molar amount of the carboxylic anhydride. For example, the amount can be 0.01 mol to 3 mol relative to 1 mol of the carboxylic anhydride.

In this step, components other than the first raw material, the second raw material, the solvent, and the reaction control agent may be contained for the purpose of improving the performance of the thermosetting resin. For example, a functional material may be contained for the purpose of enhancing the mechanical strength, electrical characteristics, thermal conductivity, heat resistance, cold resistance, abrasion resistance, water absorption resistance, chemical resistance, radiation resistance, and surge resistance of the thermosetting resin. More specifically, a chemical foaming agent, a thermally expandable microcapsule, a hollow-forming particle having a core-shell structure, a pore forming agent such as a high-boiling point solvent, and the like are included.

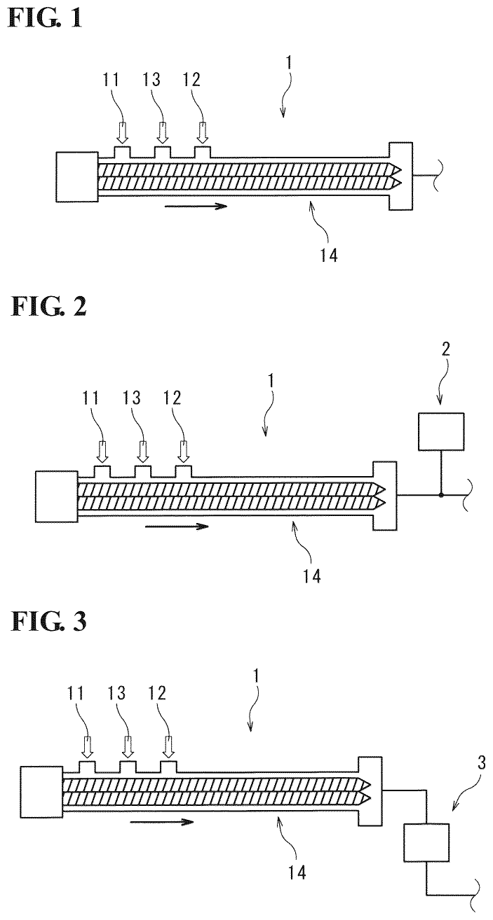

An example of this step will be described with reference to FIG. 1. As shown in FIG. 1, a twin-screw extruder 1 includes a second raw material supply section 11 for supplying a second raw material, a solvent supply section 13 for supplying a solvent, a first raw material supply section 12 for supplying a first raw material, and a mixing section 14 for mixing the first raw material, the second raw material, and the solvent to perform a polymerization reaction. In FIG. 1, second raw material supply section 11, solvent supply section 13, and first raw material supply section 12 are arranged in this order from the upstream side, but continuous productivity can be ensured even when this order is appropriately changed.

The first raw material is supplied in fixed amount from first raw material supply section 12, and the second raw material is supplied in fixed amount from second raw material supply section 11, respectively. First raw material supply section 12 and second raw material supply section 11 may be equipped with feeders.

First raw material supply section 12 and second raw material supply section 11 may further be equipped with side feeders.

The solvent is supplied in a fixed amount from solvent supply section 13. Solvent supply section 13 may be provided with a pump. When a reaction control agent is used, it is preferably supplied from solvent supply section 13.

The prepolymer solution obtained in mixing section 14 is recovered from a discharge port (not shown) disposed on the downstream side of mixing section 14.

### (Viscosity Measuring Step)

In this step, the viscosity of the prepolymer solution obtained by the mixing step is measured, and an amount of the reaction control agent supplied in the mixing step is determined based on a measurement value of the viscosity obtained by the measuring. The viscosity of the prepolymer solution can be easily controlled by the method of manufacturing the prepolymer solution including this step.

The measurement of the viscosity in this step is preferably performed with a vibration viscometer. Since the vibration viscometer can measure the viscosity in line, the prepolymer can be manufactured without impairing the continuous productivity of the prepolymer solution. Furthermore, by automatically measuring the viscosity with a vibration viscometer, the control of the supply amount of the reaction control agent can be automated based on the measured viscosity information, and the control of the viscosity of the prepolymer solution can be automated.

An example of this step will be described with reference to FIG. 2. As shown in FIG. 2, the viscosity of the prepolymer solution discharged from twin-screw extruder 1 is measured by a vibration viscometer 2 disposed in the flow path. Vibration viscometer 2 may be disposed not only in the flow path but also in a stirring tank described later.

### (Stirring Step)

In this step, the prepolymer solution obtained by the mixing step is stirred. The method of manufacturing the prepolymer solution includes this step, and thus it is possible to reduce the variation in the viscosity of the prepolymer solution.

The stirring in this step is preferably performed using a stirrer. The stirring conditions are not particularly limited and can be appropriately determined.

The stirring temperature is preferably 20° C. to 200° C., more preferably 40° C. to 110° C. In this case, the temperature for forming the polymer can be sufficiently ensured without gelation due to excessive curing of the prepolymer solution.

An example of this step will be described with reference to FIG. 3. As shown in FIG. 3, the prepolymer solution discharged from twin-screw extruder 1 is supplied to a stirring tank 3. The prepolymer solution stirred in stirring tank 3 is discharged to the flow path by a pump (not shown) or the like.

### <Method of Manufacturing of Insulated Electric Wire>

The method of manufacturing an insulated electric wire is the method of manufacturing an insulated electric wire including a conductor and an insulating layer covering the conductor, the method includes: a step of applying (hereinafter, also referred to as “application step”) a prepolymer solution obtained by the method of manufacturing a prepolymer solution to an outer peripheral side of the conductor; and a step of heating (hereinafter, also referred to as “heating step”) the prepolymer solution applied to the conductor.

The method of manufacturing an insulated electric wire uses the prepolymer solution obtained by the method of manufacturing a prepolymer solution as a material for forming an insulating layer, and thus an insulated electric wire having appropriate characteristics can be manufactured. More specifically, according to the method of manufacturing an insulated electric wire, an insulated electric wire having excellent film elongation, a high dielectric breakdown voltage, and a low dielectric constant can be manufactured.

The conductor usually includes metal as a main component. The metal is not particularly limited, but is preferably copper, a copper alloy, aluminum, or an aluminum alloy. By using the above-mentioned metal for the conductor, an insulated electric wire having good processability, conductivity, and the like can be obtained. The conductor may contain other components such as known additives in addition to the metal as the main component.

The cross-sectional shape of the conductor is not particularly limited, and various shapes such as a circle, a square, and a rectangle can be adopted. The size of the cross section of the conductor is not particularly limited, and can be appropriately determined according to the use of the insulated electric wire.

### (Application Step)

In the application step, the outer peripheral side of the conductor is applied with the prepolymer solution. As a method of applying the prepolymer solution to the outer peripheral side of the conductor, for example, a method using a applying apparatus including a storage tank storing the prepolymer solution and a applying die can be mentioned. According to this applying apparatus, the prepolymer solution adheres to the outer peripheral side of the conductor as the conductor is inserted into the storage tank, and then the prepolymer solution is applied to a uniform thickness as the conductor passes through the applying die.

### (Heating Step)

In the heating step, the prepolymer solution applied to the conductor in the application step is heated. By this heating, the solvent of the prepolymer solution is volatilized, and the prepolymer is cured to form a thermosetting resin. In this way, the insulating layer is formed. The prepolymer solution is obtained by the above-described method of manufacturing the prepolymer solution, and thus has a high-concentration. Thus, the amount of the solvent to be volatilized in the heating step is relatively small, which is advantageous in terms of production cost.

The apparatus used in the heating step is not particularly limited, and for example, a cylindrical baking furnace that is long in the running direction of the conductor can be used. The heating method is not particularly limited, and the heating can be performed by a conventionally known method such as hot air heating, infrared heating, or high-frequency heating.

The heating temperature can be set to, for example, 300° C. to 800° C., and the heating time can be set to 5 seconds to 1 minute. When the heating temperature or the heating time is less than the lower limit, volatilization of the solvent or formation of the insulating layer becomes insufficient, and the appearance, electrical characteristics, mechanical characteristics, thermal characteristics, and the like of the insulated electric wire may be deteriorated. To the contrary, when the heating temperature is higher than the upper limit, foaming of the insulating layer or a decrease in mechanical characteristics may be caused by excessively rapid heating. When the heating time exceeds the upper limit, the productivity of the insulated electric wire may be reduced.

The application step and the heating step are usually repeated a plurality of times. In this way, the thickness of the insulating layer can be increased. At this time, the hole diameter of the applying die is appropriately adjusted in accordance with the number of repetitions.

### OTHER EMBODIMENTS

The embodiments disclosed herein are to be considered in all respects as illustrative and not restrictive. The scope of the present invention is not limited to the configurations of the above-described embodiments, but is defined by the scope of claims, and is intended to include all modifications within the meaning and scope equivalent to the scope of claims.

### EXAMPLE

The present invention will be described in more detail with reference to the following examples, but the present invention is not limited to these examples.

### Test Example 1

In this test example, the influence of the mixing method on the prepolymer solution was tested according to the following method.

The abbreviations of the components used for the preparation of the prepolymer solution are shown below.
PMDA: pyromellitic dianhydride
ODA: 4,4′-diaminodiphenyl ether
DMAc: N,N-dimethylacetamide

### [No. 1-1]

### (Preparation of Prepolymer Solution)

A PMDA powder as a first raw material, an ODA powder as a second raw material, and DMAc as a solvent were continuously supplied to a twin-screw extruder (“HYPER KTX30” manufactured by Kobe Steel, Ltd., screw size: 32 mm, L/D: 56) in amounts such that the target solid content of the resulting prepolymer solution was 28% by mass. The mixing ratio (molar ratio) of PMDA and ODA was 97:103. The first raw material and the second raw material were reacted in the twin-screw extruder under the conditions of a temperature of 80° C., a rotational speed of 200 rpm, and a raw material residence time of 3 minutes, thereby obtaining prepolymer solution No. 1-1 as a polyimide precursor. Thereafter, the apparatus was operated for 2 hours, and it was confirmed that the prepolymer solution could be continuously manufactured. The obtained prepolymer solution had the solid content of 28.1% by mass, and the viscosity of 29.4 Pa-s. The obtained polyimide precursor had Mw of 45,900, Mn of 15,300, and Mw/Mn of 3.0.

The solid content and viscosity of the prepolymer solution, and Mw, Mn and Mw/Mn of the polyimide precursor were measured according to the following methods.

### (Solid Content)

The prepolymer solution was dried at 250° C. for 2 hours, and a mass Wo before drying and a mass W₁ after drying were measured, and the solid content (unit:% by mass) was calculated by W₁/W₀×100.

### (Viscosity)

The viscosity was measured at a measurement temperature of 30° C. using an E-type viscosity meter (“TV-25” manufactured by Toki Sangyo Co., Ltd).

### (Mw, Mn, and Mw/Mn)

The prepolymer solution was analyzed by “GPC system” manufactured by Tosoh Corporation to calculate Mn, Mw, and Mw/Mn of the prepolymer. N-methyl-2-pyrrolidone in which 30 mmol phosphate and 10 mmol lithium bromide were dissolved was used as a developing solution for the analyses. Polystyrene was used as a standard substance. The column used for the analyses was two “TSKgeI GMH HR-H” columns connected in series, and the guard column used was “TSK Guard Colum HHR-H”, both available from Tosoh Corporation. The measurement was performed at a flow rate of 0.5 mL/min for a measurement time of 60 minutes.

### (Production of Insulated Electric Wire)

As the conductor, a round copper line having a conductor mean radius (mean radius) of 1 mm was used. An insulating layer having an average thickness of 30 μm was formed by repeatedly applying the prepolymer solution No. 1-1 to the surface of the conductor and heating the conductor applied with the prepolymer solution No. 1-1 in a heating furnace at a set temperature of 450° C., thereby producing an insulated electric wire No. 1-1.

### [Nos. 1-2 to 1-4]

### (Preparation of Prepolymer Solution)

Prepolymer solutions Nos. 1-2 to 1-4 were prepared in the same manner as in No. 1-1 except that the target solid content of the prepolymer solution and the mixing ratio (molar ratio) of PMDA and ODA were changed to those shown in Table 1 below. The apparatus was operated for 2 hours, and it was confirmed that the prepolymer solution could be continuously manufactured. The solid content and viscosity of the obtained prepolymer solution, and Mw, Mn, and Mw/Mn of the obtained polyimide precursor are shown in Table 1 below.

### (Production of Insulated Electric Wire)

An insulated electric wire No. 1-2 was produced in the same manner as in No. 1-1 except that the prepolymer solution No. 1-2 was used. Insulated electric wires Nos. 1-3 and 1-4 were produced in the same manner as in No. 1-1 except that the prepolymer solutions Nos. 1-3 and 1-4 were used, and the prepolymer solutions were heated to 80° C. and applied to the surface of the conductor.

### [No. 1-5]

### (Preparation of Prepolymer Solution)

A PMDA powder as a first raw material, an ODA powder as a second raw material, and DMAc as a solvent were continuously supplied to the static mixer (“1, 1/2-N60-331-1” manufactured by NORITAKE CO., LIMITED, inside diameter: 41 mm, total length: 400 mm, number of elements: 6), in amounts such that the target solid content of the obtained prepolymer solution was 15% by mass. The mixing ratio (molar ratio) of PMDA and ODA was 97:103. The static mixer is a device without extruder mechanism. The first raw material and the second raw material were reacted in the static mixer under the conditions of a temperature of 80° C. and a residence time of 3 minutes to obtain a prepolymer solution No. 1-5 as a polyimide precursor. Thereafter, the apparatus was operated for 2 hours, and it was confirmed that the prepolymer solution could be continuously manufactured. The solid content of the obtained prepolymer solution was 15.1% by mass, and the viscosity was 0.20 Pa-s. Mw of the obtained polyimide precursor was 41,200, Mn was 13,600, and Mw/Mn was 3.0.

### (Production of Insulated Electric Wire)

An insulated electric wire No. 1-5 was produced in the same manner as in No. 1-1 except that the prepolymer solution No. 1-5 was used instead of the prepolymer solution No. 1-1.

### [No. 1-6]

Preparation of a prepolymer solution was attempted in the same manner as in No. 1-5 except that the first raw material, the second raw material, and the solvent were supplied in amounts such that the target solid content of the obtained prepolymer solution was 28% by mass. However, since a backflow of the material occurred in the static mixer at the time when 1 minute elapsed from the start of the operation of the apparatus, the operation of the apparatus was stopped. Thus, a prepolymer solution having a target solid content could not be obtained. The backflow of the material is considered to be caused by a significant increase in the viscosity of the material in the static mixer.

### [Evaluation]

The film elongation, the dielectric breakdown voltage, and the relative permittivity of the insulated electric wires Nos. 1-1 to 1-5 produced above were measured by the following methods.

### (Film Elongation)

The insulated electric wire from which the conductors were removed to form a tubular insulating layer was subjected to a tensile test using a tensile tester (“Autograph AGS-X” manufactured by SHIMADZU CORPORATION) at a speed of 10 mm/min with a chuck-to-chuck spacing of 20 mm, and the film elongation (elongation at break) (unit:%) was measured. The results are shown in the row of “film elongation” in Table 1 below.

### (Dielectric Breakdown Voltage)

In accordance with JIS-C3216-5:2011, an AC voltage was applied between the two stranded wires and the voltage was raised at 500 V/sec, and the voltage (unit: kV/μm) at the time of dielectric breakdown was measured. The dielectric breakdown voltage was measured for five samples each, and the average value was adopted. The results are shown in the row of “dielectric breakdown voltage” in Table 1 below.

### (Relative Permittivity)

The measurement was performed in accordance with JIS-C2138:2007. The results are shown in the row of “relative permittivity” in Table 1 below.

The results of Nos. 1-1 to 1-6 are shown in Table 1 below. In Table 1, “-” indicates that the corresponding item was not measured. In Table 1, “twin-screw extrusion” in the row of “mixing method” indicates that the prepolymer solution was prepared using a twin-screw extruder, and “static” indicates that the prepolymer solution was prepared using a static mixer. In Table 1, “A” in the row of “continuous productivity” indicates that the prepolymer solution could be continuously manufactured, “B” indicates that the prepolymer solution could be continuously manufactured but the viscosity was high, and thus a step of reducing the viscosity to a level at which an insulated electric wire could be manufactured by heating the prepolymer solution to 80° C. was required, and “C” indicates that the prepolymer solution could not be continuously manufactured.

TABLE 1

| | No. 1-1 | No. 1-2 | No. 1-3 | No. 1-4 | No. 1-5 | No. 1-6 |
|---|---|---|---|---|---|---|
| MIXING METHOD | TWIN- | TWIN- | TWIN- | TWIN- | STATIC | STATIC |
| | SCREW | SCREW | SCREW | SCREW | | |
| | EXTRUSION | EXTRUSION | EXTRUSION | EXTRUSION | | |
| TARGET SOLID CONTENT [mass %] | 28 | 32 | 36 | 40 | 15 | 28 |
| MIXING RATIO OF PMDA AND ODA (molar ratio) | 97:103 | 97:103 | 97:103 | 95:105 | 97:103 | 97:103 |
| VISCOSITY [Pa · s] | 29.4 | 81.9 | 414.2 | 409.1 | 0.20 | — |
| SOLID CONTENT [mass %] | 28.1 | 32.4 | 36.0 | 40.2 | 15.1 | — |
| Mw | 45,900 | 46,300 | 41,200 | 35,000 | 41,200 | — |
| Mn | 15,300 | 15,900 | 14,300 | 12,000 | 13,600 | — |
| Mw/Mn | 3.0 | 2.9 | 2.9 | 2.9 | 3.0 | — |
| CONTINUOUS PRODUCTIVITY | A | A | B | B | A | C |
| FILM ELONGATION [%] | 43 | 41 | 39 | 23 | 37 | — |
| DIELECTRIC BREAKDOWN VOLTAGE [kV/μm] | 0.48 | 0.47 | 0.46 | 0.40 | 0.45 | — |
| RELATIVE PERMITTIVITY | 3.2 | 3.2 | 3.1 | 3.2 | 3.3 | — |

As described above, in Nos. 1-1 to 1-4 in which the twin-screw extruder was used, a prepolymer solution having a high solid content could be continuously manufactured. In No. 1-5 and No. 1-6 using the apparatus having no extruder mechanism, only the prepolymer solution No. 1-5 having a low solid content could be continuously manufactured, and a prepolymer solution having a high solid content could not be continuously manufactured. Thus, from the results of Test Example 1, it was found that a prepolymer solution having a high solid content could be continuously manufactured by using the extruder. Furthermore, it was found that the insulated electric wires Nos. 1-1 to 1-3 were superior to the insulated electric wire No. 1-5 in all of the items of the film elongation, the dielectric breakdown voltage, and the relative permittivity.

### Test Example 2

In this test example, the influence of the addition of the reaction control agent on the prepolymer solution was tested according to the following method.

### [No. 2-1]

### (Preparation of Prepolymer Solution)

A prepolymer solution No. 2-1 was prepared in the same manner as in the case of the prepolymer solution No. 1-1, except that 0.33 mol of H₂O as a reaction control agent was supplied to the twin-screw extruder per mol of PMDA, and the mixing ratio (molar ratio) of PMDA to ODA was set to 100:100. The solid content of the obtained prepolymer solution was 28.3% by mass, and the viscosity was 8.3 Pa s. Mw of obtained the polyimide precursor was 32,300, Mn was 10,300, and Mw/Mn was 3.1.

### (Production of Insulated Electric Wire)

An insulated electric wire No. 2-1 was produced in the same manner as in No. 1-1 except that the prepolymer solution No. 2-1 was used instead of the prepolymer solution No. 1-1.

### [Nos. 2-2 to 2-16]

A prepolymer solution was prepared in the same manner as in No. 2-1 except that the kind of the reaction control agent and the supply amount were changed to the amounts shown in Table 2 below, and then an insulated electric wire was produced. The solid content and viscosity of the obtained prepolymer solution, and Mw, Mn and Mw/Mn of the obtained polyimide precursor are shown in Table 2 below.

### [No. 2-17]

As an example of preparing a prepolymer solution without using a reaction control agent to produce an insulated electric wire, No. 1-1 in the above <Test example 1> was designated as No. 2-17.

### [Evaluation]

The film elongation, the dielectric breakdown voltage, and the relative permittivity of the insulated electric wires Nos. 2-1 to 2-16 produced above were measured in the same manner as in the above <Test example 1>. The results are shown in Table 2 below. The data of No. 2-17 in Table 2 below are the data of No. 1-1 in Table 1 above.

TABLE 2

| | No. 2-1 | No. 2-2 | No. 2-3 | No. 2-4 | No. 2-5 | No. 2-6 | No. 2-7 | No. 2-8 | No. 2-9 |
|---|---|---|---|---|---|---|---|---|---|
| TARGET SOLID CONTENT | 28 | 28 | 28 | 32 | 36 | 40 | 28 | 28 | 28 |
| [mass %] | | | | | | | | | |
| REACTION CONTROL | WATER | WATER | WATER | WATER | WATER | WATER | METH- | METH- | METH- |
| AGENT | | | | | | | ANOL | ANOL | ANOL |
| AMOUNT OF REACTION | 33 | 25 | 20 | 20 | 20 | 35 | 30 | 20 | 15 |
| CONTROL AGENT [mol %] | | | | | | | | | |
| MIXING RATIO OF PMDA | 100:100 | 100:100 | 100:100 | 100:100 | 100:100 | 100:100 | 100:100 | 100:100 | 100:100 |
| AND ODA (molar ratio) | | | | | | | | | |
| VISCOSITY [Pa · s] | 8.3 | 15.1 | 27.9 | 80.5 | 410.2 | 420.3 | 9.0 | 16.3 | 25.8 |
| SOLID CONTENT [mass %] | 28.3 | 28.2 | 28.0 | 32.1 | 35.8 | 40.2 | 28.1 | 28.1 | 28.1 |
| Mw | 32,300 | 36,700 | 43,800 | 41,200 | 41,000 | 22,000 | 33,200 | 37,900 | 42,900 |
| Mn | 10,300 | 12,000 | 15,300 | 14,500 | 14,000 | 7,800 | 10,800 | 12,500 | 14,800 |
| Mw/Mn | 3.1 | 3.1 | 2.9 | 2.8 | 2.9 | 2.8 | 3.1 | 3.0 | 2.9 |
| FILM ELONGATION [%] | 72 | 79 | 81 | 80 | 78 | 65 | 80 | 85 | 91 |
| DIELECTRIC | 0.49 | 0.52 | 0.51 | 0.51 | 0.50 | 0.49 | 0.49 | 0.49 | 0.53 |
| BREAKDOWN VOLTAGE | | | | | | | | | |
| [kV/μm] | | | | | | | | | |
| RELATIVE PERMITTIVITY | 3.0 | 3.0 | 3.0 | 3.0 | 3.1 | 3.1 | 3.0 | 3.0 | 3.0 |

| | No. 2-10 | No. 2-11 | No. 2-12 | No. 2-13 | No. 2-14 | No. 2-15 | No. 2-16 | No. 2-17 |
|---|---|---|---|---|---|---|---|---|
| TARGET SOLID CONTENT | 32 | 36 | 40 | 28 | 28 | 28 | 28 | 28 |
| [mass %] | | | | | | | | |
| REACTION CONTROL | METHANOL | METHANOL | METHANOL | ETHANOL | ETHANOL | PROPANOL | BUTANOL | — |
| AGENT | | | | | | | | |
| AMOUNT OF REACTION | 15 | 15 | 33 | 45 | 35 | 55 | 70 | 0 |
| CONTROL AGENT [mol %] | | | | | | | | |
| MIXING RATIO OF PMDA | 100:100 | 100:100 | 100:100 | 100:100 | 100:100 | 100:100 | 100:100 | 97:103 |
| AND ODA (molar ratio) | | | | | | | | |
| VISCOSITY [Pa · s] | 78.4 | 389.1 | 398.1 | 14.2 | 23.6 | 29.2 | 26.5 | 29.4 |
| SOLID CONTENT [mass %] | 32.2 | 36.3 | 40.3 | 28.0 | 28.2 | 27.9 | 28.0 | 28.1 |
| Mw | 41,900 | 43,200 | 21,400 | 35,600 | 40,200 | 45,200 | 43,100 | 45,900 |
| Mn | 15,000 | 15,300 | 7,500 | 12,100 | 13,800 | 15,300 | 15,000 | 15,300 |
| Mw/Mn | 2.8 | 2.8 | 2.9 | 2.9 | 2.9 | 3.0 | 2.9 | 3.0 |
| FILM ELONGATION [%] | 90 | 90 | 71 | 79 | 82 | 76 | 72 | 43 |
| DIELECTRIC | 0.52 | 0.52 | 0.51 | 0.50 | 0.50 | 0.49 | 0.49 | 0.48 |
| BREAKDOWN VOLTAGE | | | | | | | | |
| [kV/μm] | | | | | | | | |
| RELATIVE PERMITTIVITY | 3.0 | 3.0 | 3.1 | 3.1 | 3.0 | 3.1 | 3.1 | 3.2 |

As described above, in Nos. 2-1 to 2-16 in which the reaction control agent was used, the viscosity of the prepolymer solution suitable for the production of the insulated electric wire could be obtained as in No. 2-17 while substantially equimolar amounts of PMDA and ODA were used. In addition, in Nos. 24 to 2-6 and Nos. 2-7 to 2-9, the result was obtained that the viscosity reduced as the supply amount of the reaction control agent increased. Thus, from the results of Test example 2, it was found that the viscosity of the prepolymer solution can be adjusted by using the reaction control agent.

Furthermore, the insulated electric wires Nos. 2-1 to 2-16 showed better results in all of the items of the film elongation, the dielectric breakdown voltage, and the relative permittivity than the insulated electric wire No. 2-17. This result is considered to be due to the fact that the mixing ratio of PMDA and ODA is equimolar.

### Test Example 3

In this test example, the correlation between the measurement value of the E-type viscosity meter and the measurement value of the vibration viscometer was examined according to the following method.

Eighteen samples were prepared, in which the viscosity at 30° C. measured by using an E-type viscosity meter (“TV-25” manufactured by Toki Sangyo Co., Ltd) was uniformly dispersed in a range of from 200 mPa-s to 20,000 mPa s on the logarithmic scale. The viscosity of these 18 samples at 30° C. was measured using a vibration viscometer (“FVM72A-VM-200T3” manufactured by SEKONIC CORPORATION). When the measurement value of the E-type viscosity meter and the measurement value of the vibration viscometer were plotted on the x-axis and the y-axis of the log-log graph, respectively, it was confirmed that the measurement value of the E-type viscosity meter and the measurement value of the vibration viscometer were positively correlated (R²=0.96).

From the results of Test example 3, it is considered that the viscosity can be measured without stopping the production line or the like by using a vibration viscometer as an in-line viscosity meter when continuously manufacturing a prepolymer solution. It is also considered that the measurement of viscosity can be automated. Furthermore, from the results of Test Example 2 and Test Example 3, it is considered that the viscosity of the prepolymer solution can be adjusted by controlling the supply amounts of the reaction control agent based on the measurement value of the viscosity measured by the vibration viscometer.

### Test Example 4

In this test example, the influence of the presence or absence of the stirring step on the prepolymer solution was tested according to the following method.

### [No. 4-1]

### (Preparation of Prepolymer Solution)

A prepolymer solution No. 4-1 was continuously prepared in the same manner as in the case of No. 2-3 except that the operation of the apparatus was performed for 5 hours.

### (Production of Insulated Electric Wire)

An insulated electric wire No. 4-1 was produced in the same manner as in No. 1-1 except that the prepolymer solution No. 4-1 was used.

### [No. 4-2]

### (Preparation of Prepolymer Solution)

A prepolymer solution was prepared in the same manner as in No. 4-1, and the obtained prepolymer solution was supplied to a stirring tank and stirred for 30 minutes under the conditions of a temperature of 80° C. and a stirring rotational speed of 20 rpm. The prepolymer solution after stirring was designated as prepolymer solution No. 4-2.

### (Production of Insulated Electric Wire)

An insulated electric wire No. 4-2 was produced in the same manner as in No. 4-1 except that the prepolymer solution No. 4-2 was used.

### [Evaluation]

The prepolymer solutions Nos. 4-1 and 4-2 prepared above were evaluated for the variation in the viscosity by the following method. Further, the insulated electric wires Nos. 4-1 and 4-2 produced above were evaluated for the variation in film elongation by the following method.

### (Variation in Viscosity)

The viscosity at 30° C. was measured for samples (N=31) sampled at intervals of 10 minutes using the E-type viscosity meter. From the measurement results, the average value (arithmetic mean), standard deviation a, and coefficient of variation (CV value) of the viscosity were calculated. The coefficient of variation was calculated by dividing the standard deviation a by the average value. The results are shown in Table 3 below, together with the maximum viscosity and the minimum viscosity.

### (Variation in Film Elongation)

The film elongation was measured for the samples (N=9) sampled at intervals of 75 minutes by the same method as in the section of (Film elongation) of the above <Test example 1>. From the measurement results, the average value (arithmetic average), standard deviation σ, and coefficient of variation (CV value) of the film elongation were calculated. The coefficient of variation was calculated by dividing the standard deviation a by the average value. The results are shown in Table 3 below, together with the maximum film elongation and the minimum film elongation.

TABLE 3

| | No. 4-1 | No. 4-2 |
|---|---|---|
| PRESENCE OR ABSENCE OF STIRRING | ABSENCE | PRESENCE |
| AVERAGE VISCOSITY [Pa · s] | 28.2 | 29.3 |
| MAXIMUM VISCOSITY [Pa · s] | 45.7 | 33.2 |
| MINIMUM VISCOSITY [Pa · s] | 19.2 | 25.7 |
| STANDARD DEVIATION σ OF | 5.9 | 2.1 |
| VISCOSITY [Pa · s] | | |
| COEFFICIENT OF VARIATION OF | 0.21 | 0.072 |
| VISCOSITY | | |
| AVERAGE FILM ELONGATION [%] | 81 | 80 |
| MAXIMUM FILM ELONGATION [%] | 94 | 86 |
| MINIMUM FILM ELONGATION [%] | 53 | 75 |
| STANDARD DEVIATION σ OF FILM | 13 | 3.2 |
| ELONGATION [%] | | |
| COEFFICIENT OF VARIATION OF FILM | 0.16 | 0.040 |
| ELONGATION | | |

As described above, in No. 4-2 in which stirring was performed after mixing by the twin-screw extruder, the variation in the viscosity of the prepolymer solution could be reduced as compared with No. 4-1 in which stirring was not performed. Further, in No. 4-2, the variation in the film elongation of the insulated electric wire was also smaller than that in No. 4-1. Thus, from the results of Test example 4, it was found that the viscosity of the prepolymer solution and the variation in the film elongation of the insulated electric wire could be reduced by stirring after mixing by the extruder.

### REFERENCE SIGNS LIST

1 twin-screw extruder
11 second raw material supply section
12 first raw material supply section
13 solvent supply section
14 mixing section
2 vibration viscometer
3 stirring tank

1. A method of continuously manufacturing a prepolymer solution in which a prepolymer as a precursor of a thermosetting resin is dissolved in a solvent, the method comprising:
mixing, using an extruder, a first raw material, a second raw material that reacts with the first raw material to form the prepolymer, and the solvent.

2. The method of manufacturing a prepolymer solution according to claim 1, wherein, in the mixing, a reaction control agent is further mixed.

3. The method of manufacturing a prepolymer solution according to claim 2, further comprising measuring a viscosity of the prepolymer solution obtained by the mixing,
wherein an amount of the reaction control agent supplied in the mixing is determined based on a measurement value of the viscosity obtained by the measuring.

4. The method of manufacturing a prepolymer solution according to claim 1, further comprising stirring the prepolymer solution obtained by the mixing.

5. The method of manufacturing a prepolymer solution according to claim 1, wherein a solid content of the prepolymer solution is 20% by mass to 50% by mass.

6. The method of manufacturing a prepolymer solution according to claim 1, wherein the prepolymer has a group capable of forming an imide group through a dehydration reaction, the first raw material is a carboxylic anhydride, and the second raw material is a diamine compound.

7. The method of manufacturing a prepolymer solution according to claim 6, wherein the prepolymer is a polyimide prepolymer, and the carboxylic anhydride is a tetracarboxylic dianhydride.

8. The method of manufacturing a prepolymer solution according to claim 1, wherein the extruder is a twin-screw extruder.

9. The method of manufacturing a prepolymer solution according to claim 3, wherein, in the measuring, the viscosity is measured with a vibration viscometer.

10. The method of manufacturing a prepolymer solution according to claim 4, wherein the stirring is performed under a condition of a temperature of 20° C. to 200° C.

11. A method of manufacturing an insulated electric wire including a conductor and an insulating layer covering the conductor, the method comprising:
applying a prepolymer solution obtained by the method of manufacturing a prepolymer solution according to claim 1 to an outer peripheral side of the conductor; and
heating the prepolymer solution applied to the conductor.

12. The method of manufacturing a prepolymer solution according to claim 2, further comprising stirring the prepolymer solution obtained by the mixing.

13. The method of manufacturing a prepolymer solution according to claim 3, further comprising stirring the prepolymer solution obtained by the mixing.

14. The method of manufacturing a prepolymer solution according to claim 2, wherein a solid content of the prepolymer solution is 20% by mass to 50% by mass.

15. The method of manufacturing a prepolymer solution according to claim 3, wherein a solid content of the prepolymer solution is 20% by mass to 50% by mass.

16. The method of manufacturing a prepolymer solution according to claim 4, wherein a solid content of the prepolymer solution is 20% by mass to 50% by mass.

17. The method of manufacturing a prepolymer solution according to claim 2, wherein the prepolymer has a group capable of forming an imide group through a dehydration reaction, the first raw material is a carboxylic anhydride, and the second raw material is a diamine compound.

18. The method of manufacturing a prepolymer solution according to claim 3, wherein the prepolymer has a group capable of forming an imide group through a dehydration reaction, the first raw material is a carboxylic anhydride, and the second raw material is a diamine compound.

19. The method of manufacturing a prepolymer solution according to claim 4, wherein the prepolymer has a group capable of forming an imide group through a dehydration reaction, the first raw material is a carboxylic anhydride, and the second raw material is a diamine compound.

20. The method of manufacturing a prepolymer solution according to claim 5, wherein the prepolymer has a group capable of forming an imide group through a dehydration reaction, the first raw material is a carboxylic anhydride, and the second raw material is a diamine compound.
